(19) United States
(12) Patent Application Publication
(10) Pub. No.: US 2022/0129596 A1
(43) Pub. Date: Apr. 28, 2022

(54) A COMPUTERIZED METHOD OF PRODUCING A CUSTOMIZED DIGITAL INSTALLATION GUIDE FOR BUILDING A SEALED INSTALLATION OF ONE OR MORE CABLES, PIPES OR WIRES BY ASSEMBLING ORDERED AND DELIVERED TRANSIT COMPONENTS TO FORM A TRANSIT

(71) Applicant: Roxtec AB, Karlskrona (SE)

(72) Inventors: Daniel STRÄNG, Karlskrona (SE); Andreas KARLSSON, Karlskrona (SE); Pär HAMMARSTRÖM, Karlskrona (SE); Robert GUSTAVSSON, Karlskrona (SE)

(73) Assignee: Roxtec AB, Karlskrona (SE)

(21) Appl. No.: 17/429,694

(22) PCT Filed: Feb. 10, 2020
(86) PCT No.: PCT/SE2020/050131

§ 371 Date: Aug. 10, 2021

(30) Foreign Application Priority Data
Feb. 11, 2019 (SE) 1950154-3

(51) Int. Cl. G06F 30/13; G06K 7/14; G06Q 10/08

(52) U.S. Cl. CPC G06F 30/13; G06Q 10/083; G06K 7/1413; G06K 7/1417

(57) ABSTRACT

A computerized method (400) of producing a customized digital installation guide for a cable, pipe or wire transit is disclosed. A database (50) of transit components (210) and associated (214) installation instruction sections (220) for the respective transit components is provided. A digital order (242) is generated (410) for a customizable transit (1) comprising selected transit components (218). An order identity (244) is assigned (420) to the generated digital order (242). In the database (50) an association (246) is stored (430) between the order identity (244) and the selected transit components (218) of the digital order (242). A machine-readable code (70) representing the order identity (244) is generated (440). A delivery (340) of the selected transit components (218) to an installation site (6) is caused (450) in accordance with the digital order (242). The generated machine-readable code (70) is associated (460) with the delivery (340). A digital installation guide request, comprising the order identity (244) as being derived by a remote computing device (100) reading (465) the machine-readable code (70) associated with the delivery (340), is received (470). The database (50) is searched (480) to determine the transit components (212) associated with the derived order identity (244). Installation instruction sections (222) for the determined transit components (218) associated with the derived order identity (244) are retrieved (490) from the database (50). The retrieved installation instruction sections (222) are compiled (500) into a customized digital installation guide (80) for building a sealed installation of one or more cables, pipes or wires (2) by assembling the delivered transit components (218) to form the transit (1).

### TECHNICAL FIELD

The present invention generally relates to the field of sealed installations of cables, pipes or wires, and more particularly to a computerized method of producing a customized digital installation guide for a cable, pipe or wire transit, the customized digital installation guide offering assistance to an installer when building a sealed installation of one or more cables, pipes or wires using a number of transit components to form a transit. The present invention also relates to a system for producing a customized digital installation guide for a cable, pipe or wire transit.

### BACKGROUND

Sealed installations of cables, pipes or wires are commonly used in many different environments, such as for cabinets, technical shelters, junction boxes and machines. They are used in a variety of different industries, such as automotive, telecom, power generation and distribution, as well as marine and offshore. The sealed installations serve to seal effectively against fluid, gas, fire, rodents, termites, dust, moisture, etc., and may involve cables for electricity, communication, computers, etc., pipes for different gases or liquids such as water, compressed air, hydraulic fluid and cooking gas, and wires for load retention.

The present applicant is a global leader in the development of cable, pipe or wires transits for sealing purposes. A transit, which may also be referred to as a lead-through, is made up of one or more transit components, typically a plurality of different transit components which upon installation at a site are assembled into a sealed installation of one or more cables, pipes or wires, thereby forming the transit. One commonly used transit type has an essentially rectangular frame, inside of which a number of modules are arranged to receive cables, pipes or wires. The modules are made of an elastic material, such as rubber or plastics, and are thus compressible and moreover adaptable to different outer diameters of the cables, pipes or wires. The modules are typically arranged side by side in one or more rows together with some kind of compression unit. The compression unit is placed between the frame and the modules in such a way that when the compression unit is expanded, the compressible modules will be compressed around the cables, wires or pipes. For ease of description, the term “cable” will be mainly used in this document, but it should be construed broadly and a person skilled in the art will realise that it normally also covers pipes or wires, or is an equivalent thereof.

Another type of transit has an essentially cylindrical form and is to be received in a sleeve, also known as a pipe sleeve, in a wall or an opening in a wall. To function in the desired way, the transit is adapted to fit snugly into the sleeve or the opening of the wall in which it is received, and the transit is adaptable to the actual mounting dimension. The mounting dimension is dictated by the inner diameter of the sleeve or the opening. The transit has a cylindrical compressible body, which is compressed axially between fittings at the opposite ends of the compressible body. By the axial compression the cylindrical body will expand radially both inwards and outwards. Furthermore, the cables received may have different outer diameters, and, thus, the module is adaptable to cables having different outer diameters.

Other types of transits are also known in the technical field, as the skilled person is well aware of per se.

When a new transit is required for a sealed installation of cables, wires or pipes at a site, a suitable number of transit components of suitable types, sizes, dimensions, etc., are typically ordered from a vendor, supplier or distributor of such transit components. The constitution and nature of the order will, of course, largely depend on the needs and requirements of the installation to be made, in terms of size, layout, grading, etc. Because of this, and because of the diversity of different types of transit components available on the market, it may be a challenging task for the installer to build the sealed installation from the ordered transit components by assembling them into a complete transit.

The installer might rely on own prior experience of similar installation work, or ask a senior colleague for help and assistance. However, there will be a risk for installation flaws particularly if the installer lacks experience from the particular kind of installation to be built. A senior colleague might not always be available.

The prior art approach of addressing these issues is to include a pre-made (e.g. printed) assembly manual in the package with the ordered transit components, which is shipped to the installer or the site. However, there are disadvantages with this approach. One disadvantage is that a very large number of assembly manuals will have to be prepared and kept in stock (again because of the aforementioned considerable diversity in installation requirements, transit types and types of transit components). This, in turn, poses a problem in waste of resources. Also, an order for a particular installation is often tailor-made to be adapted to the exact, individual needs and requirements at the site in question, so there will always be a noticeable risk that there is no pre-made assembly manual available to include with the delivery.

An additional complication is the risk of pre-made assembly manuals becoming outdated because of changes in any of the transit components involved. It is recalled that continuous development work is going on in the field of sealed installations of cables, pipes or wires.

The present inventors have identified the problems referred to above and realized, by inventive activity, that there is room for improvements.

### SUMMARY

It is accordingly an object of the invention to provide one or more improvements in the field of cable, pipe or wire transits when it comes to installation assistance.

A first aspect of the present invention therefore is a computerized method of producing a customized digital installation guide for a cable, pipe or wire transit. The method comprises providing a database of transit components and associated installation instruction sections for the respective transit components; generating a digital order for a customizable transit comprising selected transit components; assigning an order identity to the generated digital order; and storing in the database an association between the order identity and the selected transit components of the digital order.

The method further comprises generating a machine-readable code representing said order identity; causing a delivery of the selected transit components in accordance with said digital order to an installation site; and associating the generated machine-readable code with the delivery.

The method also comprises receiving a digital installation guide request comprising the order identity as being derived by a remote computing device reading the machine-readable code associated with the delivery; searching the database to determine the transit components associated with the derived order identity; retrieving, from the database, installation instruction sections for the determined transit components associated with the derived order identity; and compiling the retrieved installation instruction sections into a customized digital installation guide for building a sealed installation of one or more cables, pipes or wires by assembling the delivered transit components to form the transit.

Thus, the present invention provides a computerized method of producing a customized digital installation guide for building a sealed installation of one or more cables, pipes or wires by assembling ordered and delivered transit components to form a transit.

A second aspect of the present invention is a system for producing a customized digital installation guide for a cable, pipe or wire transit. The system comprises a database of transit components and associated installation instruction sections for the respective transit components.

The system also comprises a computerized order generating module configured for generating a digital order for a customizable transit comprising selected transit components, assigning an order identity to the generated digital order, and storing in the database an association between the order identity and the selected transit components of the digital order.

The system moreover comprises a computerized delivery handling module configured for generating a machine-readable code representing said order identity, causing a delivery of the selected transit components in accordance with said digital order to an installation site, and associating the generated machine-readable code with the delivery.

The system further comprises a computerized digital installation guide generating module configured for receiving a digital installation guide request comprising the order identity as being derived by a remote computing device reading the machine-readable code associated with the delivery, searching the database to determine the transit components associated with the derived order identity, retrieving—from the database—installation instruction sections for the determined transit components associated with the derived order identity, and compiling the retrieved installation instruction sections into a customized digital installation guide for building a sealed installation of one or more cables, pipes or wires by assembling the delivered transit components to form the transit.

One advantage of embodiments of the present invention is that a customized digital installation guide can be tailor-made for every individual order. This improves user experience and reduces the risk for installation errors. Also, there is no need for bulk installation manuals, which will avoid waste of resources.

Another advantage made possible thanks to embodiments of the present invention is that the digital installation guide may be compiled very close in time to the actual transit installation work at the site. This means that up-to-date installation instructions may be provided; recent technical design updates to transit components may be reflected in the digital installation guide which can be generated “on the fly”.

Additional features of the method and system according to the first and second aspects, as well as their functionality and structure, together with problems solved and advantages obtained, will be described in the detailed description section, defined in the appended claims and illustrated in the drawings.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Objects, features and advantages of embodiments of the invention will appear from the following detailed description, reference being made to the accompanying drawings.

FIG. 1 is a schematic isometric view of a transit comprising a plurality of different transit components which upon installation at a site have been assembled into a sealed installation of a plurality of cables.

FIG. 2A is a schematic isometric view of a first type of transit component in the form of an essentially rectangular frame.

FIG. 2B is a schematic isometric view of a second type of transit component in the form of a compressible module.

FIG. 2C is a schematic isometric view of a third type of transit component in the form of a stayplate.

FIG. 2D is a schematic isometric view of a fourth type of transit component in the form of a wedge or compression unit.

FIG. 2E is a schematic isometric view of a fifth type of transit component in the form of a wedge clip.

FIG. 3 is a schematic isometric view of a more complex transit.

FIG. 4 is a schematic block diagram of a computing device used in embodiments of the invention.

FIG. 5 schematically illustrates a technical context in which embodiments of the invention may be exercised.

FIG. 6 is a schematic illustration of the composition of a database included in embodiments of the invention.

FIG. 7 is a schematic illustration of a system for producing a customized digital installation guide for a cable, pipe or wire transit in accordance with embodiments of the invention.

FIG. 8 is a schematic flowchart diagram of a method of for producing a customized digital installation guide for a cable, pipe or wire transit in accordance with embodiments of the invention.

### DETAILED DESCRIPTION

Embodiments of the invention will now be described with reference to the accompanying drawings. The invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular embodiments illustrated in the accompanying drawings is not intended to be limiting of the invention. In the drawings, like numbers refer to like elements.

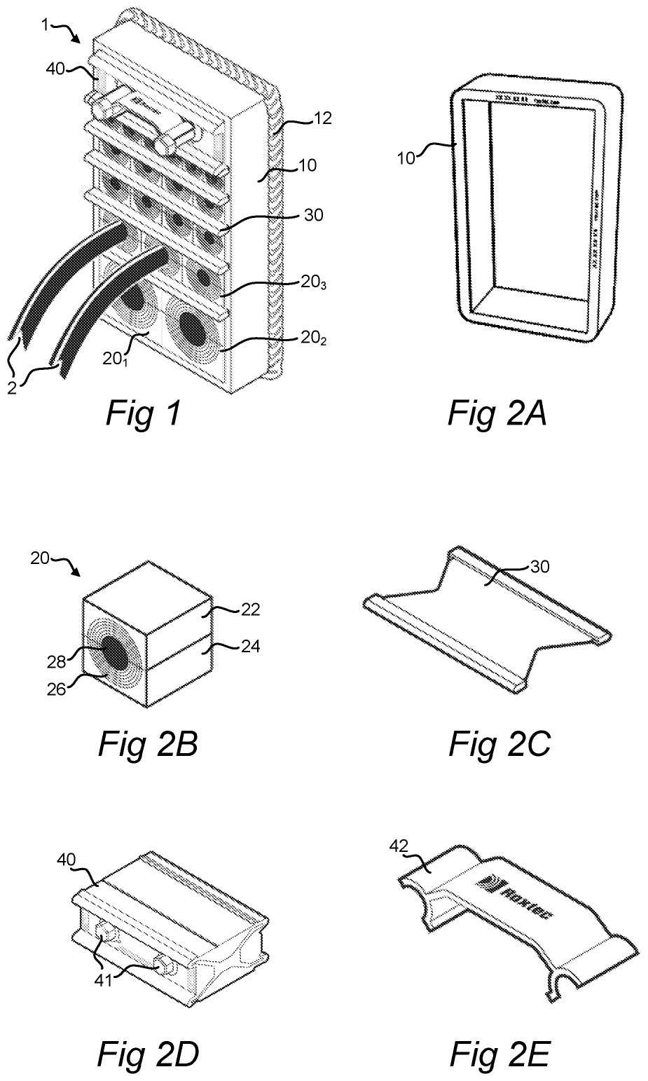

FIG. 1 schematically illustrates a transit 1, also known as a lead-through, comprising a plurality of different transit components 10, 20, 30, 40, 42 which upon installation at a site have been assembled into a sealed installation of a plurality of cables 2. Generally, the transit components which make up a transit may be of different types, sizes, dimension, grades, etc., and may exist as a single instance or as multiple instances, depending on implementation.

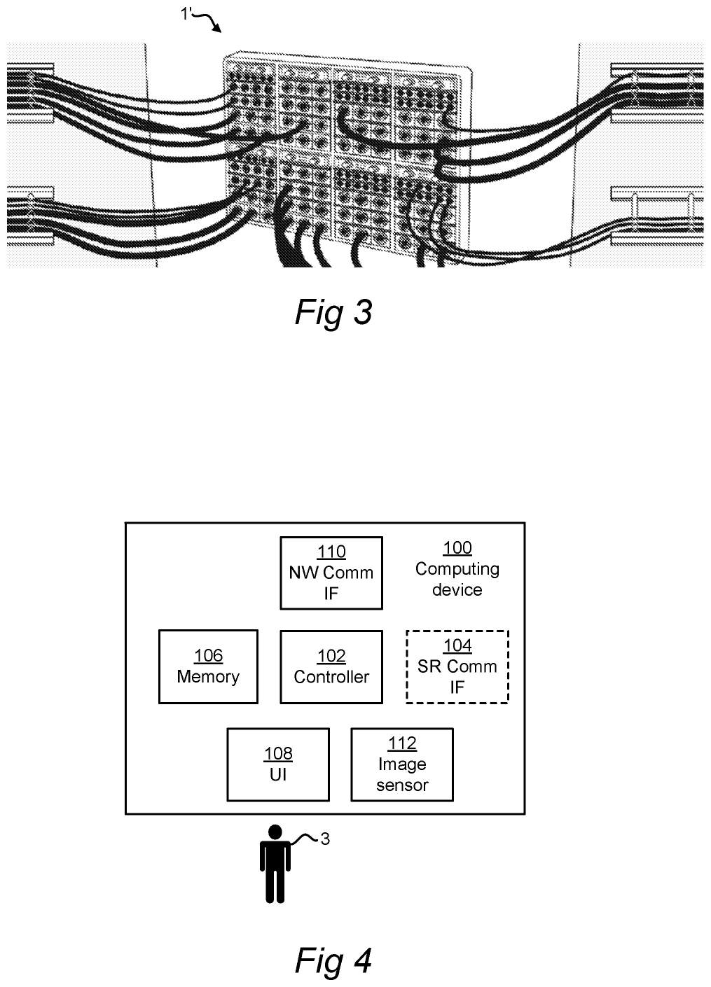

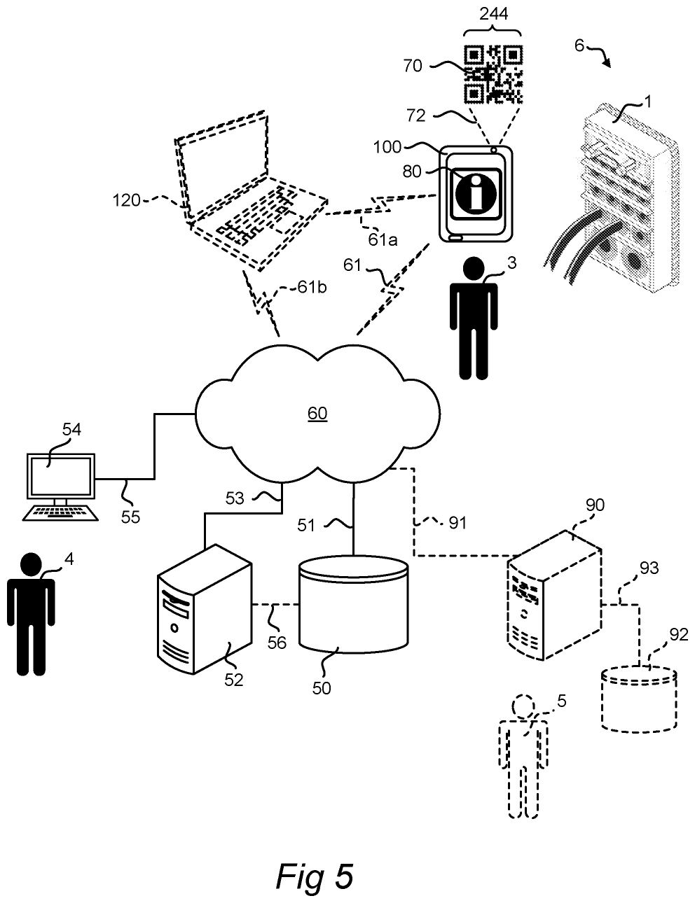

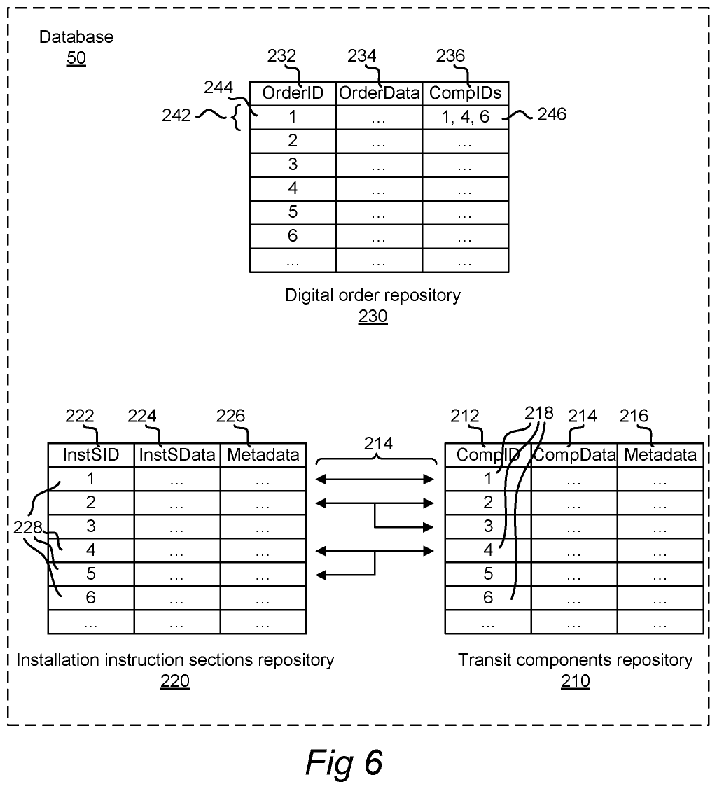

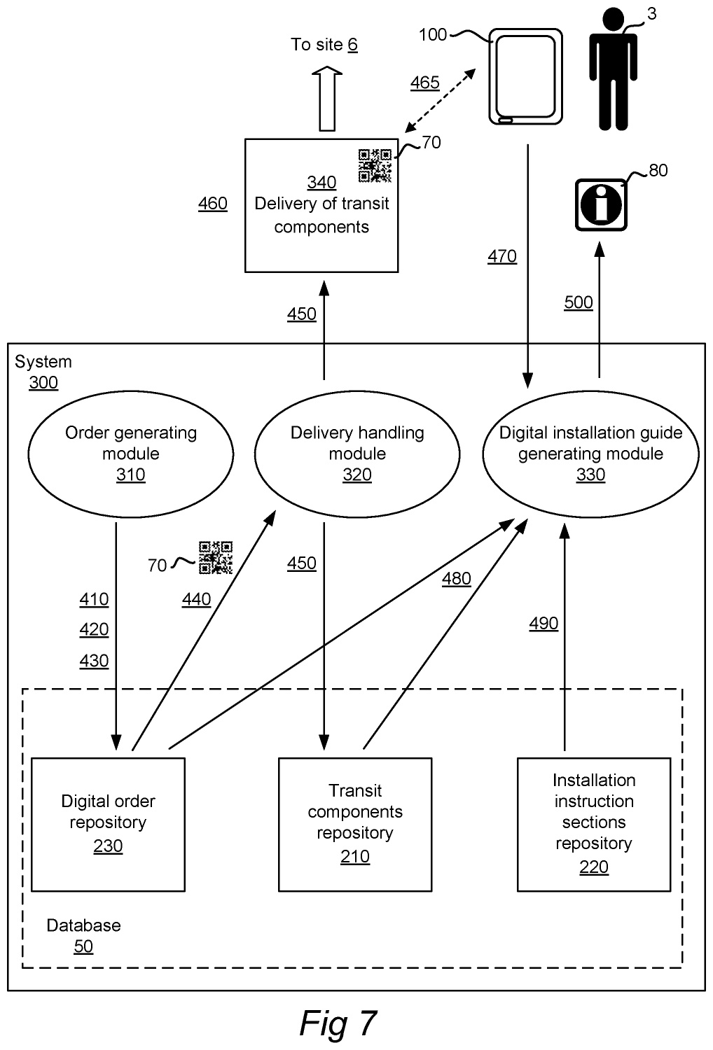

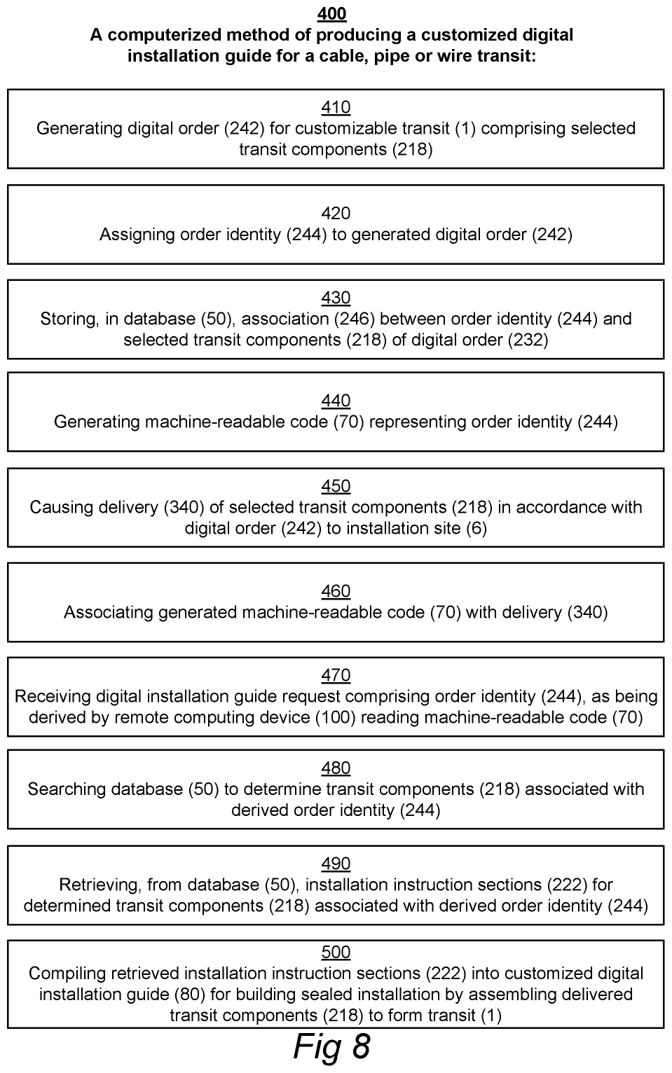

As seen in FIG. 1, the transit 1 comprises a frame 10, inside of which a plurality of compressible modules are arranged in different sizes and numbers (only three of the compressible modules being indicated as 201, 202 and 203 in FIG. 1). The frame 10 of the transit 1 is mounted by means of a gasket, sealing or weld joint 12. A compressible module 20 is shown in FIG. 2B. The compressible module 20 has a box-shaped body which is divided into two halves 22, 24. A number of layers 26 of elastic material are concentrically arranged in the body 22, 24 around a center core 28. By removing the core 28 and peeling off a suitable number of layers 26 at installation, the compressible module 20 may be adapted to securely engage a cable 2 among cables of different diameters. In the example seen in FIG. 1, only two cables 2 are mounted in two respective modules 20; the remainder of the modules 20 in FIG. 1 are currently not used for cable lead-through and therefore still have the respective cores 28 in place.

As is clear from FIG. 1, a (main) transit component type (such as a compressible module 20) may in turn appear in different (sub) types, for instance differentiated by size (see modules 202 and 203 in FIG. 1).

FIG. 2C illustrates a third type of transit component in the form of a stayplate 30 which, as is seen in FIG. 1, is used to separate different rows of compressible modules 20 in the frame 10.

FIG. 2D illustrates a fourth type of transit component in the form of a wedge or compression unit 40. A fifth type of transit component in the form of a wedge clip 42 is seen in FIG. 2E. The compression unit 40 is placed between the frame 10 and the modules 20, or between individual modules 20, in such a way that when the compression unit is expanded, the compressible modules will be compressed around the cables 2 such that a sealed installation is achieved. When the compression unit has been sufficiently expanded, its tightening members (bolts or screws) 41 will protrude far enough for the wedge clip 42 to be attached onto them. Hence, when the wedge clip 42 is attached, it is an indication that the compression unit has been sufficiently expanded. Alternatively or additionally, the wedge clip 42 may serve to prevent accidental loosening (de-expansion) of the compression unit 40.

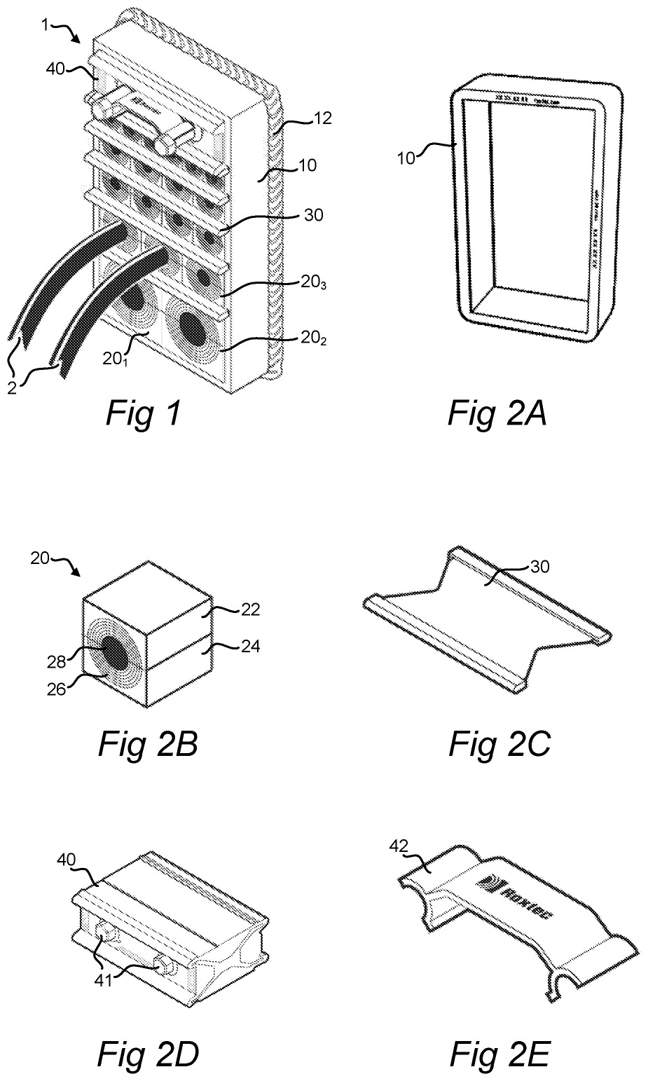

It is to be noticed that different transits may vary considerably in size and complexity, depending on the nature and implementation requirements at the installation site in question. FIG. 3 shows an example of a more complex transit 1′.

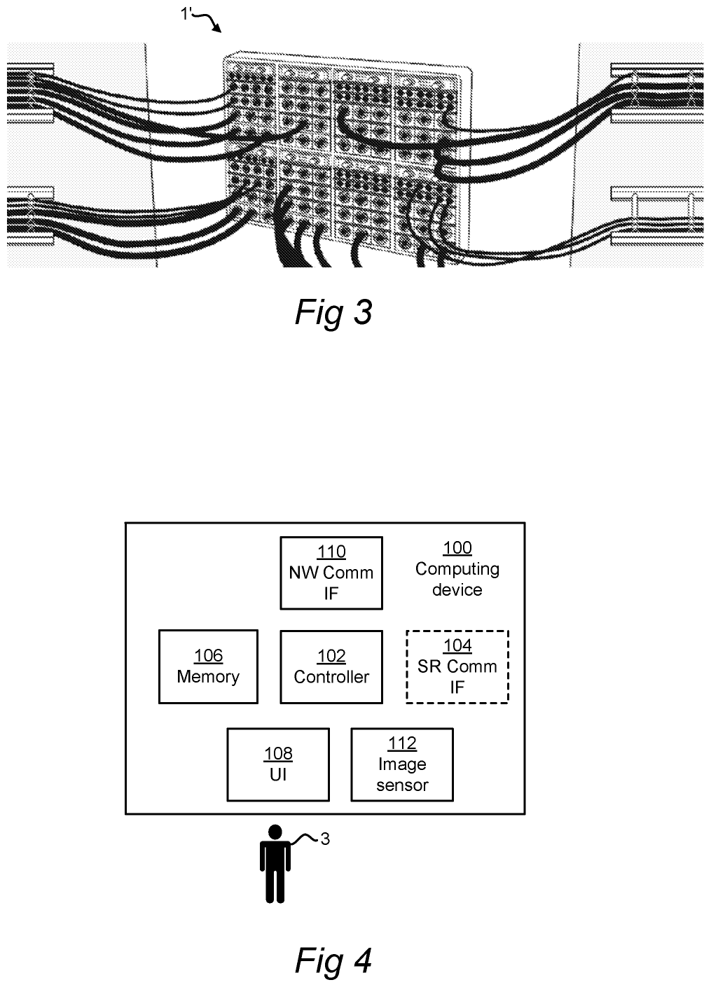

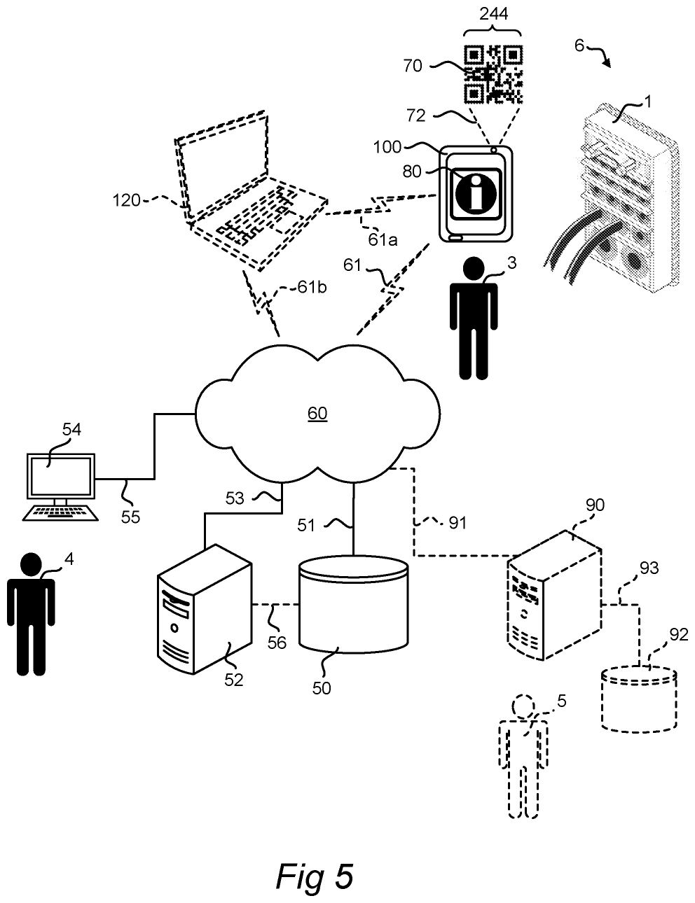

FIG. 4 is a schematic block diagram of a computing device 100 which is used in embodiments of the invention by a person faced with the task of building a sealed installation of one or more cables, pipes or wires at a site by using a number of transit components and assembling them to form a transit. The context in which the computing device 100 may be used by such a person—who will be referred to as an installer in this document—when embodiments of the invention are exercised will be further described later with reference to FIG. 5.

As seen in FIG. 4, the computing device 100 comprises a controller 102, a memory 106, a user interface 108 towards the installer 3, a network communication interface 110, an image sensor 112, and, optionally, a short-range communication interface 104.

The controller 102 may, for instance, be implemented as a central processing unit (CPU), digital signal processor (DSP), application-specific integrated circuit (ASIC), field-programmable gate array (FPGA), or generally by any electronic circuitry capable of performing the functionalities as described herein, in any number or combination.

When applicable, the short-range communication interface 104 may, for instance, be implemented as NFC, RFID or Bluetooth.

The memory 106 may, for instance, be implemented in any commonly known technology for electronic memories, such as ROM, RAM, SRAM, DRAM, CMOS, FLASH, DDR or SDRAM.

The network communication interface 110 may, for instance, be implemented as TCP/IP, IEEE 802.11, IEEE 802.15, ZigBee, WirelessHART, WiFi, Bluetooth, WCDMA, HSPA, GSM, UTRAN, UMTS, LTE, LTE+, LTE Advanced, D-AMPS, CDMA2000, FOMA, TD-SCDMA ASI, CANbus, ProfiBus, Modbus, or as LoRa or other low frequency wireless data communication technology, or combinations thereof.

The image sensor 112 may be implemented as a digital camera or generally as, for instance, a semiconductor charge-coupled device (CCD), an active pixel sensor in complementary metal-oxide-semiconductor (CMOS) technology, or an active pixel sensor in N-type metal-oxide-semiconductor (NMOS, Live MOS) technology.

In some embodiments, the computing device 100 may be implemented as a tablet computer (also known as surfpad), as a personal digital assistant or as a smartphone or other mobile terminal, wherein the user interface 108 advantageously comprises a touch-sensitive display screen, or as a smart watch or smart glasses with their typical respective user interface 108.

Reference is now made to FIG. 5 which schematically illustrates a technical context in which embodiments of the invention may be exercised.

A server computer resource 52 and a database 50 are provided for allowing a user 4 to order a customizable transit 1 comprising selected transit components, for causing delivery of the selected transit components to a site 6, for generating a customized digital installation guide 80 for the ordered transit, and for allowing an installer 3 to retrieve the customized digital installation guide 80 when building a sealed installation of one or more cables, pipes or wires 2 by assembling the delivered transit components to form the transit 1 at the site 6.

The server computer resource 52 can be a physical service computer device (server computer hardware) or a logical, cloud-based server computer function. Likewise, the database 50 may be a physical database device or a logical, cloud-based database function. In the former case, the physical database device 50 may be included in/implemented by the physical service computer device 52, or these devices may be interconnected for communication as seen at 56.

In the latter case, the cloud-based server computer function 52 and the cloud-based database function 50 may communicate over a communication network 60, which may be compliant with, for instance, TCP/IP, IEEE 802.11, IEEE 802.15, ZigBee, WirelessHART, WiFi, Bluetooth, WCDMA, HSPA, GSM, UTRAN, UMTS, LTE, LTE +, LTE Advanced, D-AMPS, CDMA2000, FOMA, TD-SCDMA ASI, CANbus, ProfiBus, Modbus, or as LoRa or other low frequency wireless data communication technology, or combinations thereof. Such communication is seen at 53 and 51.

A user 4 may use a computer 54 for ordering a customizable transit comprising selected transit components. The computer 54 is communicatively connected with the server computer resource 52 and the database 50 via the communication network 60, as seen at 55. The computer 54 may, for instance, be implemented as a workstation computer, personal computer, laptop computer, tablet computer, personal digital assistant, smartphone or other mobile terminal, having an operating system and being appropriately programmed to perform the functionalities described in this document.

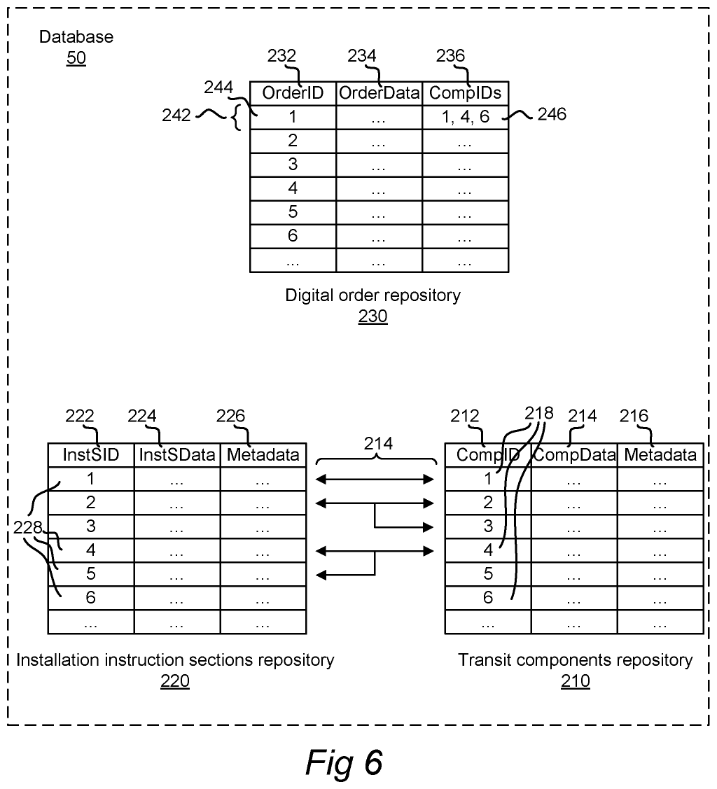

The composition of the database 50 in one or more exemplifying embodiments is shown in FIG. 6.

The database 50 comprises a transit components repository 210 which contains definitions of a variety of transit components, such as for instance any or all of the transit components described above for FIGS. 1 and 2A-2E. Each transit component in the transit components repository 210 has a unique component ID 212 and component data 214 which defines the particulars of the transit component in terms of technical parameters, design, requirements, etc. There may also be metadata 216 which defines how different transit components are interrelated, for instance how they may or may not be used in combination, or in what order they need to be installed.

The database 50 also comprises an installation instruction sections repository 220 which contains installation instruction sections for the different transit components in the transit components repository 210. Each installation instruction section has a unique instruction section ID 222, as well as instruction section data 224 in the form of explanatory or informative text, image(s), video or audio, in any combination or number. Metadata 226 may also be provided for the installation instruction sections.

The installation instruction sections in the installation instruction sections repository 220 are associated, as seen at 214, with the relevant transit components in the transit components repository 210. The associations 214 may be one-to-one, as seen in FIG. 6 where installation instruction section #1 is associated with transit component #1. The associations 214 may also be one-to-many, as seen for installation instruction section #2 which is associated with transit components #2 and #3. Moreover, the associations 214 may be many-to-one, as can be seen for installation instruction sections #4 and #5 which are associated with transit component #4. The associations 214 may be represented by the metadata 226 and/or 216, or as separate pointer data in the database 50.

The database 50 further comprises a digital order repository 230. For each order made by the user 4 (or other users of the system), there will be one digital order or record in the digital order repository 230. (Different orders may then form a hyper-order that may pertain to different transits, even for different sites. This is however not at the core of the present invention). Each digital order has a unique order ID 232 and also order data 234 to define the order (for instance, customer information, delivery details, shipping conditions, payment conditions, etc). The digital order moreover contains information 236 on the selected transit components of the digital order. The information 236 contains the component IDs of the selected transit components, thereby allowing a reference to the transit components repository 210. The information 236 (or, alternatively or additionally, the order data 234) may also contain other relevant data, such as the number of transit components of the same type included in the order, the layout of the transit components of the customizable transit which is the subject of the digital order, etc.

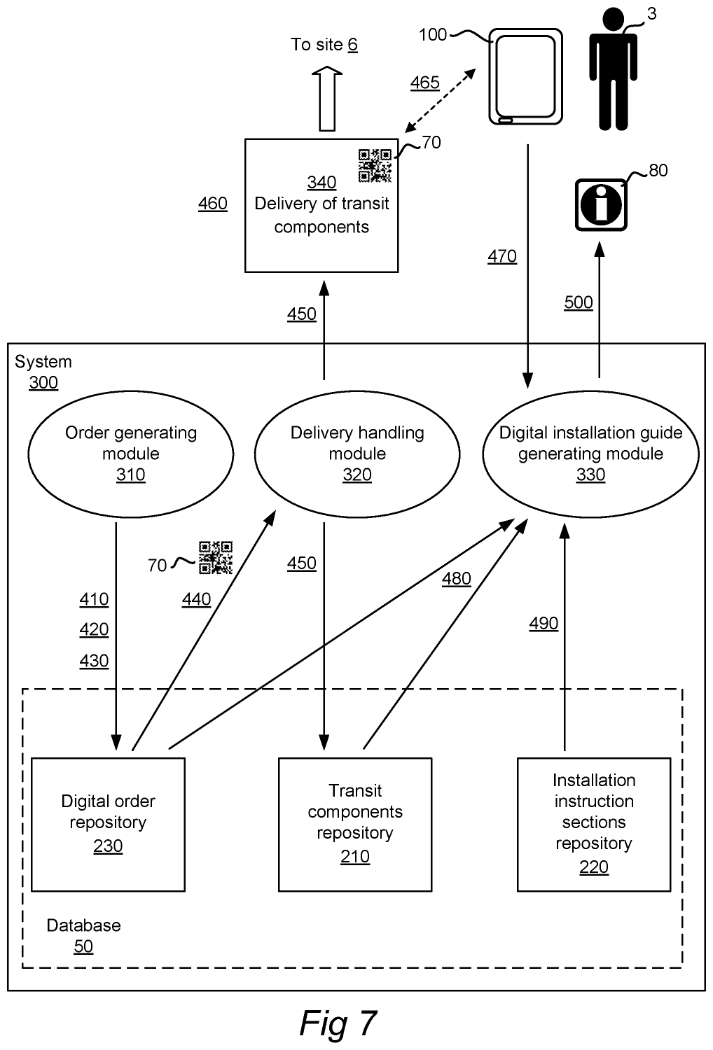

Reference is now made to FIG. 7, illustrating a system 300 for producing a customized digital installation guide 80 for a cable, pipe or wire transit 1 in accordance with embodiments of the invention.

The system 300 comprises the database 50 as described above for FIG. 6. The system 300 further comprises a computerized order generating module 310, a computerized delivery handling module 320 and a computerized digital installation guide generating module 330. The modules 310, 320, 330 may be software being executable by the server computer resource 52 in FIG. 4.

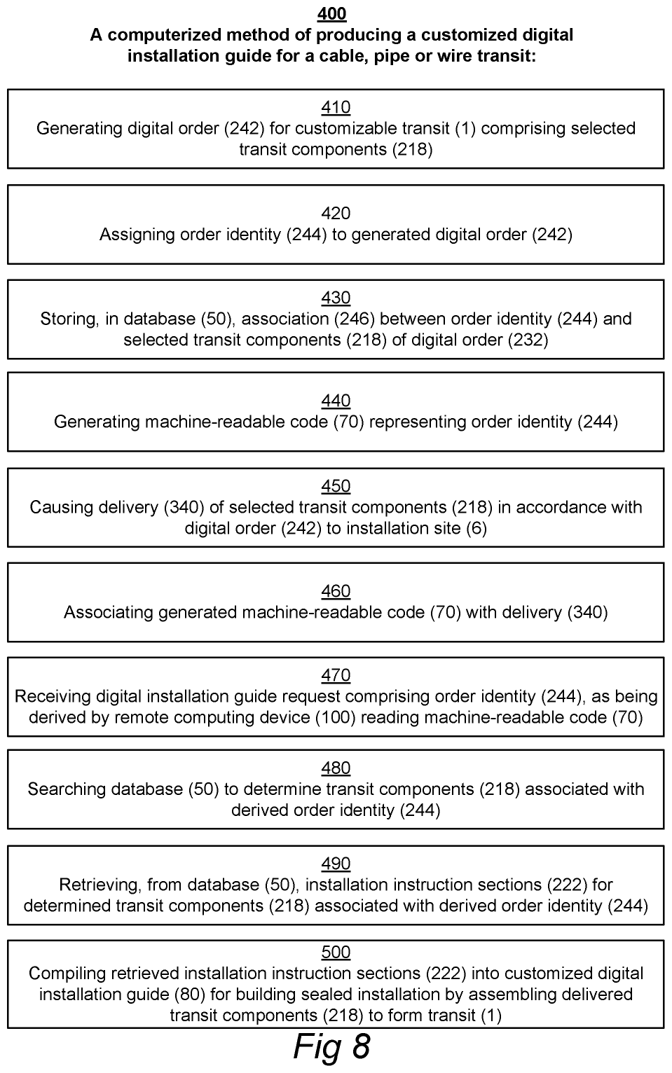

The computerized order generating module 310 is configured for generating a digital order 242 for a customizable transit 1 which comprises transit components 218 selected by the user 4 when placing the order at the computer 54 in FIG. 5. This is seen at 410 in FIG. 7, and this step is recited—together with further steps 420-500—in more detail in FIG. 8.

The computerized order generating module 310 is further configured for assigning 420 an order identity 244 to the generated digital order 242. As can be seen in the example shown in FIG. 6, the order ID 232 field of the generated digital order 242 in the digital order repository 230 is thus set to have the order identity 244=#1.

The computerized order generating module 310 is then configured for storing 430 in the database 50 an association 246 between the order identity 244 and the selected transit components 218 of the digital order 242. As can be seen in the example shown in FIG. 6, the information 236 of the generated digital order 242 in the digital order repository 230 is thus set to contain components IDs #1, #4 and #6, which link to the selected transit components 218 in the transit components repository 210.

The computerized delivery handling module 320 may typically be invoked when it is time to deliver the selected transit components 218 of the digital order 242 to the site 6. This may occur instantly after the generation of the digital order 242 in steps 410-430, or at a later occasion depending on, for instance the terms of the digital order 242 and the current availability of the selected transit components 218 for delivery.

The computerized delivery handling module 320 is configured for generating 440 a machine-readable code 70 which contains or otherwise represents the order identity 244 of the digital order 242. The machine-readable code 70 may advantageously be an optically readable code, preferably a two-dimensional barcode such as QR (Quick Response). In other embodiments, the machine-readable code 240 may be an optically readable, one-dimensional barcode, such as UPC (Universal Product Code) or EAN (European Article Number/International Article Number), or any other suitable optical code. In still other embodiments, the machine-readable code 240 may be a non-optical code which is electronically readable rather than optically.

The computerized delivery handling module 320 is then configured for causing 450 a delivery 340 of the selected transit components 218 in accordance with the digital order 242 to the installation site 6. The computerized delivery handling module 320 is also configured for associating 460 the generated machine-readable code 70 with the delivery 340. Examples of such associations 460 will be given further below.

The computerized digital installation guide generating module 330 is configured for receiving 470 a digital installation guide request comprising the order identity 244 as being derived by the remote computing device 100 reading 465 (see FIG. 7) the machine-readable code 70 associated with the delivery 340.

The computerized digital installation guide generating module 330 is also configured for searching 480 the database 50 to determine the transit components 212 associated with the derived order identity 244. The computerized digital installation guide generating module 330 thus queries the digital order repository 230 for the digital order having the derived order identity 244 as order ID. In the example in FIG. 6, this means the digital order 242 having order ID #1. The computerized digital installation guide generating module 330 then reads the information 236 for that digital order 242 and finds that the selected transit components 218 are the ones that are represented by component IDs #1, #4 and #6 in the transit components repository 210.

The computerized digital installation guide generating module 330 is further configured for retrieving 490, from the database 50, installation instruction sections 222 for the determined transit components 218 associated with the derived order identity 244. The computerized digital installation guide generating module 330 thus determines the installation instruction sections 222 in the installation instruction sections repository 220 that are associated 214 with the selected transit components 218, i.e. the ones being represented by component IDs #1, #4 and #6 in the transit components repository 210 in the example of FIG. 6. Continuing with the example of FIG. 6, the computerized digital installation guide generating module 330 thus identifies the installation instruction sections 222 as those having installation instruction section IDs #1, #2, #4 and #5.

The computerized digital installation guide generating module 330 is then configured for compiling 500 the retrieved installation instruction sections 222 into a customized digital installation guide 80 for building a sealed installation of one or more cables, pipes or wires 2 by assembling the delivered transit components 218 to form the transit 1. The customized digital installation guide 80 thus compiled may be made available to the installer 3 in different appropriate ways. Preferably, however, the installer 3 uses the computing device 100 as a means for retrieving and presenting the customized digital installation guide 80, using a connection 61 to the communication network 60 in FIG. 5.

In some embodiments, the generated machine-readable code 70 may conveniently be included in or on a package (e.g. carton box) which contains the selected transit components 218 that are to be delivered to the site 6. When the machine-readable code 70 is an optically readable code, it may, for instance, be printed on a label which is adhered to the package, or on a document or other piece of paper which is put inside the package. When the machine-readable code 70 is a non-optical, electronically readable code, it may, for instance, be stored in an RFID chip, NFC tag or another electronically readable data carrier. The RFID chip, NFC tag or other data carrier may be attached to the package, to any of the selected transit components 218 in the package, or otherwise be put inside the package.

In such embodiments, when or after the delivery 340 has arrived at the site 6, the remote computing device 100 may read 465 the machine-readable code 70 associated with the delivery 340. This may involve the remote computing device 100 capturing an image of the optically readable code 70 provided on or in the package, and then processing the image to derive the embedded machine-readable code 70 (for instance QR code). Alternatively, it may involve the remote computing device 100 using an appropriate electronic code reader to read the non-optical code from the aforementioned RFID chip, NFC tag or other data carrier provided with the package.

The remote computing device 100 may then send the aforementioned digital installation guide request comprising the derived order identity 244 to the system 300 shown in FIG. 7, where the computerized digital installation guide generating module 330 will receive the request at 470, as previously discussed.

The remote computing device 100 will then receive the customized digital installation guide 80 as provided at 500 in FIG. 7, as previously discussed. Finally, the remote computing device 100 may present the received customized digital installation guide 80 to the installer 3 at the site 6, preferably by showing the customized digital installation guide 80 in the user interface 108 (see FIGS. 4 and 5).

In embodiments where the machine-readable code 70 is a non-optical, electronically readable code, the system 300 in FIG. 7 may—as an alternative to storing the code in an RFID chip, NFC tag or another electronically readable data carrier as described above—be configured to send a digital message containing the generated electronically readable code to the remote computing device 100, preferably using the communication network 60 in FIG. 5. The remote computing device 100 may receive the digital message containing the generated electronically readable code, read the electronically readable code therein and derive the order identity.

The remote computing device 100 may then send the aforementioned digital installation guide request comprising the derived order identity 244 to the system 300 shown in FIG. 7, where the computerized digital installation guide generating module 330 will receive the request at 470, as previously discussed.

The remote computing device 100 will then receive the customized digital installation guide 80 as provided at 500 in FIG. 7, as previously discussed. Finally, the remote computing device 100 may present the received the customized digital installation guide 80 to the installer 3 at the site 6, preferably by showing the customized digital installation guide 80 in the user interface 108.

In alternative embodiments, a second remote computing device 120 may be used together with the computing device 100 by the installer 3, as is indicated by dashed lines in FIG. 5. The second computing device 120 may, for instance, be a laptop computer connectable to the communication network 60 as seen at 61b. The computing device 100 and the second computing device 120 may communicate by short-range data communication, as seen at 61a in FIG. 5 (cf short-range communication interface 104 in FIG. 4). In such cases, the computing device 100 may be used merely as a scanner of the machine-readable code 70, which will then be conveyed to the second computing device 120 over the short-range communication 61a. The second computing device 120 may perform the rest of the functionality of the computing device 100 in the previously described embodiments.

In further alternative embodiments, development server functionality 90 may be interfaced with the system 300 via the communication network 60, as seen at 91 in FIG. 5. The development server functionality 90 may have an associated development database 92, as seen at 93 in FIG. 5. By interfacing with the development server functionality 90, the system 300 may automatically update any of the definitions the transit components in the transit components repository 210. For instance, the component data 214 may be updated to reflect an update made at the development server functionality 90 to the particular design of individual transit components, or to reflect the addition of new transit components to the database 50 as they have been developed at the development server functionality.

Likewise, the system 300 may update any of the installation instruction sections 222 in the installation instruction sections repository 220 to account for changes made to individual transit components, or new transit components added to the database 50.

This will allow the customized digital installation guides 80 provided by the present invention to be up-to-date and continuously refined and improved, and this is as such a considerable improvement over the prior art approaches described in the background section of this document.

The invention has been described above in detail with reference to embodiments thereof. However, as is readily understood by those skilled in the art, other embodiments are equally possible within the scope of the present invention, as defined by the appended claims.

1. A computerized method of producing a customized digital installation guide for a cable, pipe or wire transit, the method comprising:
providing a database of transit components and associated installation instruction sections for the respective transit components;
generating a digital order for a customizable transit comprising selected transit components;
assigning an order identity to the generated digital order;
storing in the database an association between the order identity and the selected transit components of the digital order;
generating a machine-readable code representing said order identity;
causing a delivery of the selected transit components in accordance with said digital order to an installation site;
associating the generated machine-readable code with the delivery;
receiving a digital installation guide request comprising the order identity as being derived by a remote computing device reading the machine-readable code associated with the delivery;
searching the database to determine the transit components associated with the derived order identity;
retrieving, from the database, installation instruction sections for the determined transit components associated with the derived order identity; and
compiling the retrieved installation instruction sections into a customized digital installation guide for building a sealed installation of one or more cables, pipes or wires by assembling the delivered transit components to form the transit.

2. The computerized method as defined in claim 1, wherein the machine-readable code is an optically readable code.

3. The computerized method as defined in claim 2, wherein the machine-readable code is selected from the group consisting of:
a two-dimensional barcode; and
a one-dimensional barcode.

4. The computerized method as defined in claim 1, wherein the machine-readable code is a non-optical, electronically readable code.

5. The computerized method as defined in claim 1, the machine readable code being an optically readable code or a non-optical, electronically readable code, wherein said delivery involves a package containing the selected transit components, the method further comprising providing the generated machine-readable code in or on said package.

6. The computerized method as defined in claim 1, the machine readable code being an optically readable code or a non-optical, electronically readable code, wherein the method further comprises, when or after the delivery has arrived at the site:
the remote computing device reading the machine-readable code associated with the delivery;
the remote computing device deriving the order identity;
the remote computing device sending the digital installation guide request comprising the derived order identity;
the remote computing device receiving the customized digital installation guide; and
the remote computing device presenting the received customized digital installation guide to an installer at the site.

7. The computerized method as defined in claim 4, the method further comprising sending a digital message containing the generated electronically readable code to said remote computing device.

8. The computerized method as defined in claim 7, wherein the method further comprises:
the remote computing device receiving the digital message containing the generated electronically readable code;
the remote computing device reading the electronically readable code and deriving the order identity;
the remote computing device sending the digital installation guide request comprising the derived order identity;
the remote computing device receiving the customized digital installation guide; and
the remote computing device presenting the received customized digital installation guide to an installer at the site.

9. The computerized method as defined in claim 1, wherein each installation instruction section of the customized digital installation guide comprises explanatory or informative text, image(s), video or audio, in any combination or number.

10. The computerized method as defined in claim 1, further comprising interfacing with development server functionality to update transit components and/or installation instruction sections in the database.

11. The computerized method as defined in claim 1, further comprising interfacing with development server functionality to add new transit components and/or installation instruction sections to the database.

12. A system for producing a customized digital installation guide for a cable, pipe or wire transit, the system comprising:
a database of transit components and associated installation instruction sections for the respective transit components;
a computerized order generating module configured for:
generating a digital order for a customizable transit comprising selected transit components,
assigning an order identity to the generated digital order, and
storing in the database an association between the order identity and the selected transit components of the digital order;
a computerized delivery handling module configured for:
generating a machine-readable code representing said order identity,
causing a delivery of the selected transit components in accordance with said digital order to an installation site, and
associating the generated machine-readable code with the delivery; and
a computerized digital installation guide generating module configured for:
receiving a digital installation guide request comprising the order identity as being derived by a remote computing device reading the machine-readable code associated with the delivery;
searching the database to determine the transit components associated with the derived order identity;
retrieving, from the database, installation instruction sections for the determined transit components associated with the derived order identity, and
compiling the retrieved installation instruction sections into a customized digital installation guide for building a sealed installation of one or more cables, pipes or wires by assembling the delivered transit components to form the transit.

13. The system as defined in claim 12, wherein the machine-readable code is an optically readable code.

14. The system as defined in claim 13, wherein the machine-readable code is selected from the group consisting of:
a two-dimensional barcode; and
a one-dimensional barcode.

15. The system as defined in claim 12, wherein the machine-readable code is a non-optical, electronically readable code.

16. The system as defined in claim 12, the machine-readable code being an optically readable code or a non-optical, electronically readable code, wherein said delivery involves a package containing the selected transit components, the system further being configured for providing the generated machine-readable code in or on said package.

17. The system as defined in claim 12, the machine-readable code being an optically readable code or a non-optical, electronically readable code, the system further comprising the remote computing device, wherein the remote computing device is configured, when or after the delivery has arrived at the site, for:
reading the machine-readable code associated with the delivery;
deriving the order identity;
sending the digital installation guide request comprising the derived order identity,
receiving the customized digital installation guide; and
presenting the received customized digital installation guide to an installer at the site.

18. The system as defined in claim 15, further configured for sending a digital message containing the generated electronically readable code to said remote computing device.

19. The system as defined in claim 18, the system further comprising the remote computing device, wherein the remote computing device is configured for:
receiving the digital message containing the generated electronically readable code;
reading the electronically readable code and deriving the order identity;
sending the digital installation guide request comprising the derived order identity,
receiving the customized digital installation guide; and
presenting the received customized digital installation guide to an installer at the site.

20. The system as defined in claim 12, wherein each installation instruction section of the customized digital installation guide comprises explanatory or informative text, image(s), video or audio, in any combination or number.

21. The system as defined in claim 12, further configured for interfacing with development server functionality to update transit components and/or installation instruction sections in the database.

22. The system as defined in claim 12, further configured for interfacing with development server functionality to add new transit components and/or installation instruction sections to the database.
